(19) United States
(12) Patent Application Publication
(10) Pub. No.: US 2005/0178608 A1
(43) Pub. Date: Aug. 18, 2005

(54) Power steering device of electric motor type

(75) Inventors: Kohtaro Shiino, Kanagawa (JP); Fumiyuki Yamaoka, Kanagawa (JP); Tadaaki Fujii, Saitama (JP); Shinobu Kakizaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD.

(21) Appl. No.: 11/059,346

(22) Filed: Feb. 17, 2005

(30) Foreign Application Priority Data
Feb. 17, 2004 (JP) 2004-39723
Mar. 22, 2004 (JP) 2004-83223

(51) Int. Cl. B62D 5/04

(52) U.S. Cl. 180/444

(57) ABSTRACT

A worm wheel is mounted to a steered shaft to rotate therewith. A brushless electric motor has an output shaft and is able to generate a power for assisting turning of the steered shaft when energized. A worm gear is coaxially connected to the output shaft of the motor to constitute a combined shaft structure. The worm gear is meshed with the worm wheel. Two bearings bear axially opposite end portions of the combined shaft structure respectively.

### BACKGROUND OF THE INVENTION

1. Field of the Invention

The present invention relates in general to power steering devices of wheeled motor vehicles, and more particularly to the power steering devices of an electric motor type that uses an electric motor for assisting the driver in turning the road wheels for steering.

2. Description of the Related Art

Hitherto, various power steering devices of an electric motor type have been proposed and put into practical use in the field of the wheeled motor vehicles. The power steering devices of such electric motor type will be referred to as just an electric power steering device in the following for ease of description.

Some of them are shown in Japanese Laid-open Patent Applications, which are Tokkaihei-7-137644 and Tokkai-2002-120739.

In the electric power steering device of Tokkaihei-7-137644, an elongate output shaft of an electric motor is integrally formed with a worm gear that is meshed with a worm wheel. The elongate output shaft is rotatably supported by three bearing members, which are a first bearing member that bears one end of the shaft, a second bearing member that bears the other end of the shaft and a third bearing that bears a middle portion of the shaft. While, in the electric power steering device of Tokkai-2002-120739, an output shaft of an electric motor is arranged to pass through respective openings of a power system substrate and a control system substrate which are abreast arranged along the axis of the output shaft. A worm shaft coaxially extends from the output shaft and a worm wheel meshed with a worm gear of the worm shaft is mounted on a steered shaft that is turned by a steering wheel. A torque sensor for sensing a steering torque is also mounted on the steered shaft and electrically connected to electric elements on the control system substrate through a wire harness.

### SUMMARY OF THE INVENTION

However, due to their inherent construction, the known electric power steering devices of the above-mentioned published applications fail to have a sufficiently compact size. Furthermore, in the device of Tokkaihei-7-137644, mounting the device to a proper position needs a very complicated and thus time-consumed assembling process, and in the device of Tokkai-2002-120739, a longer wire harness has to be used for connecting the torque sensor and the electric elements on the control circuit substrate, which causes increase in the cost of the device.

It is therefore an object of the present invention to provide an electric power steering device which is free of the above-mentioned drawbacks possessed by the known electric power steering devices.

That is, in accordance with the present invention, there is provided an electric power steering device which is characterized by its compactness in size and its facility in assembling.

In accordance with a first aspect of the present invention, there is provided an electric power steering device which comprises a worm wheel mounted to a steered shaft to rotate therewith; a brushless electric motor having an output shaft, the motor being able to generate a power for assisting turning of the steered shaft when energized; a worm gear coaxially connected to the output shaft of the motor to constitute a combined shaft structure, the worm gear being meshed with the worm wheel; and two bearings that bear axially opposite end portions of the combined shaft structure respectively.

In accordance with a second aspect of the present invention, there is provided an electric power steering device which comprises a steered shaft connected to a steering wheel; a steering condition detecting device that detects a steering condition of the steered shaft; a worm wheel secured to the steered shaft to rotate therewith; a brushless electric motor having an output shaft, the motor being able to generate a power for assisting turning of the steered shaft when energized; a worm gear coaxially connected to the output shaft of the motor to constitute a combined shaft structure, the worm gear being meshed with the worm wheel; two bearings that bear axially opposite end portions of the combined shaft structure; a power system substrate on which power transistors for feeding the motor with an electric power are mounted; and a control system substrate positioned in the vicinity of both the steering condition detecting device and the worm wheel, the control system substrate carrying thereon a microcomputer by which the power transistors are controlled based on the steering condition detected by the steering condition detecting device, the control system substrate having an opened part through which the steered shaft passes.

In accordance with a third aspect of the present invention, there is provided an electric power steering device arranged between a first section that includes a steering wheel and a second section that includes steered road wheels of a motor vehicle, the electric power steering device comprising an input shaft connected to the first section; a pinion shaft connected to the second section and coaxially connected to the input shaft through a torsion bar; a worm wheel mounted to the pinion shaft to rotate therewith; a brushless electric motor arranged in such a manner that an output shaft thereof extends perpendicular to an axis of the pinion shaft; a worm gear provided by the output shaft of the motor and operatively meshed with the worm wheel; and two ball bearings only by which the output shaft is rotatably supported, the two ball bearings bearing axially opposite end portions of the output shaft respectively.

Other objects and advantages of the present invention will become apparent from the following description when taken in conjunction with the accompanying drawings.

### BRIEF DESCRIPTION OF THE DRAWINGS

FIG. 1 is a perspective view of an electric power steering device which is a first embodiment of the present invention;

FIG. 2 is a schematically illustrated exploded view of the electric power steering device of the first embodiment, which is provided for showing a positional relationship between various parts employed;

FIG. 3 is a sectional view taken along the line III-III of FIG. 1;

FIG. 4A is a sectional view of a torque sensor housing with some elements installed therein;

FIG. 4B is a sectional view of a worm wheel housing with some parts installed therein;

FIG. 5 is a sectional view taken along the line V-V of FIG. 1;

FIG. 6 is a view similar to FIG. 5, but showing a second embodiment of the present invention;

FIG. 7 is a perspective view of a shaft holding member used in the second embodiment;

FIG. 8 is a view similar to FIG. 3, but showing a third embodiment of the present invention;

FIG. 9 is a perspective view of a control system substrate that is employable in the electric power steering device of the third embodiment of FIG. 8;

FIG. 10 is a view similar to FIG. 3, but showing a fourth embodiment of the present invention;

FIG. 11 is a perspective view of a control system substrate that is employable in the electric power steering device of the fourth embodiment; and

FIG. 12 is an enlarged sectional view of the control system substrate of FIG. 11 in a condition wherein it is properly set in a given position of the device.

### DETAILED DESCRIPTION OF THE EMBODIMENTS

In the following, various embodiments of the present invention will be described in detail with reference to the accompanying drawings. Throughout the specification, substantially the same parts and elements are denoted by the same reference numerals and repeated description on the same parts and elements will be omitted.

For ease of understanding, various directional terms, such as right, left, upper, lower, rightward and the like are used in the following description. However, such terms are to be understood with respect to only a drawing or drawings on which corresponding part or portion is shown.

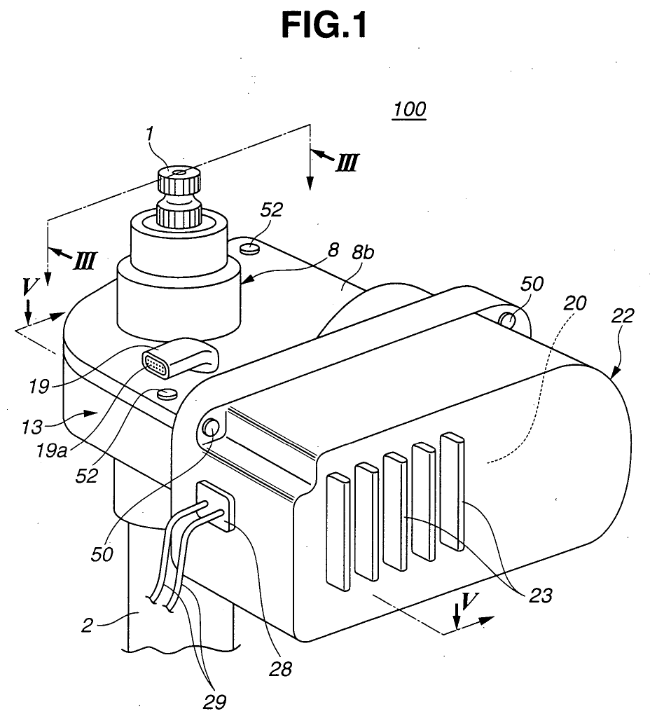

Referring to FIGS. 1 to 5, there is shown an electric power steering device 100 which is a first embodiment of the present invention.

As is seen from FIG. 1, electric power steering device 100 has generally three housings, which are a torque sensor housing 8, a worm wheel housing 13 and a motor housing 22.

Within torque sensor housing 8, there is arranged an input shaft 1 whose upper part is exposed to the outside as shown. Within worm wheel housing 13, there is arranged an upper part of a pinion shaft (or steered shaft) 2. Within motor housing 22, there is arranged a brushless motor 20.

As will be described in detail hereinafter, input shaft 1 and pinion shaft (or steered shaft) 2 are arranged on a common axis and, motor 20 has an output shaft 12 that extends perpendicular to the common axis of input and pinion shafts 1 and 2.

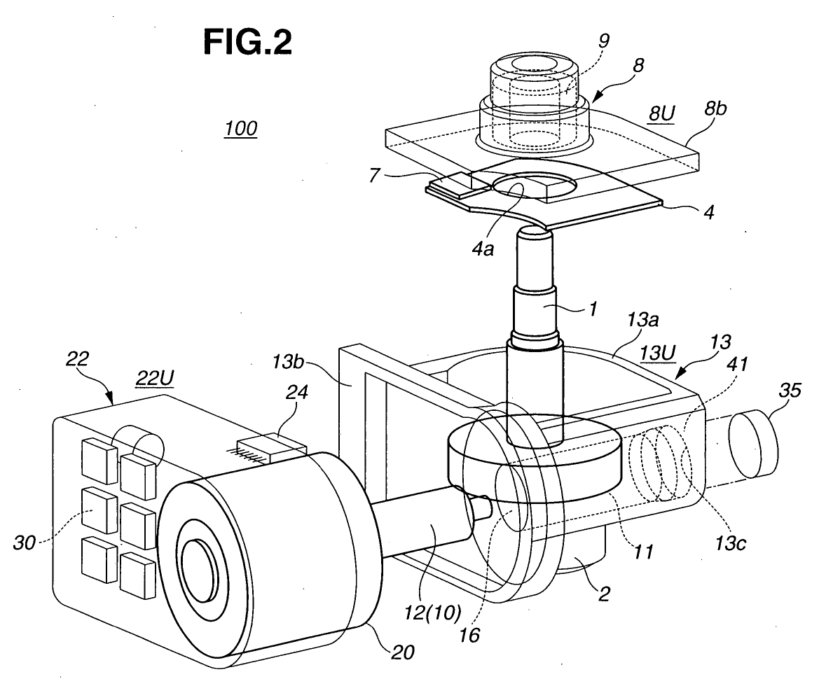

The positional relationship between the parts will be easily understood from FIG. 2. As is understood from the drawing, upon assembly, torque sensor housing 8 is mounted on an open upper side 13a of worm wheel housing 13, and motor housing 22 is mounted to an open side part 13b of worm wheel housing 13. As shown, output shaft 12 of brushless motor 20 extends perpendicular to the common axis of input and pinion shafts 1 and 2.

Although not shown in the drawings, input shaft 1 is connected to a steering wheel through an upwardly extending steering shaft, and pinion shaft 2 extends downward to be operatively connected to a rack-and-pinion type steering gear of steered road wheels. That is, pinion shaft 2 has at its lower end a pinion that is meshed with a rack of the steering gear.

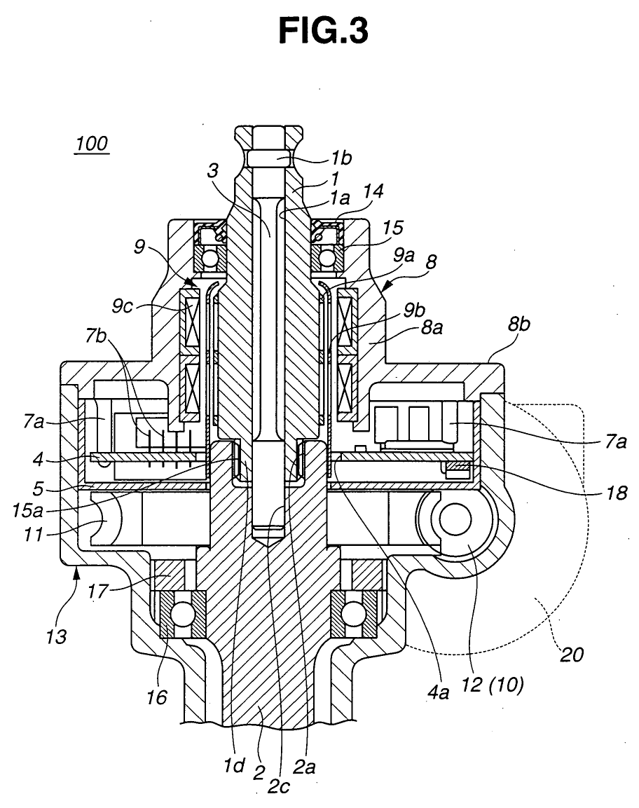

As is seen from FIG. 3, input shaft 1 and pinion shaft 2 are coaxially connected through a torsion bar 3. More specifically, torsion bar 3 is coaxially received in a through bore 1a of input shaft 1 and has an upper end fixed to input shaft 1 by means of a pin 1b and a lower end press-fitted in a bore 2c formed in an upper end of pinion shaft 2.

A major portion of input shaft 1 is rotatably received in a sensor holding part 8a of torque sensor housing 8 through a ball bearing 15.

As shown, a cylindrical smaller lower part id of input shaft 1 is concentrically received in a cylindrical bore 2a formed in the upper end of pinion shaft 2.

A so-called loose serration structure 15a is provided between cylindrical smaller lower part 1d of input shaft 1 and cylindrical bore 2a of pinion shaft 2. With this serration structure 15a, the rotational movement of input shaft 1 is transmitted to pinion shaft 2 with a given time lag. That is, there is provided a certain play between input shaft 1 and pinion shaft 2.

An annular dust cap 14 is fitted to an upper open part of torque sensor housing 8 to seal an annular clearance between torque sensor housing 8 and input shaft 1.

In a cylindrical clearance defined between the major portion of input shaft 1 and the sensor holding part 8a of torque sensor housing 8, there is arranged a magnetic type torque sensor 9.

Torque sensor 9 comprises an inner metal ring 9a that is mounted to input shaft 1 to rotate therewith and has a plurality of openings, an outer metal ring 9b that is fixed at its lower end to pinion shaft 2 to rotate therewith and has a plurality of openings and a pair of coils 9c that are tightly disposed in an annular recess (no numeral) formed on the inner surface of sensor holding part 8a of torque sensor housing 8. If desired, ball bearing 15 and coils 9c may be integrally mounted to torque sensor housing 8 through an insert molding technique. That is, in this technique, the molding of torque sensor housing 8 is so made that ball bearing 15 and coils 9c are placed in a mold and produced as an integral part of torque sensor housing 8.

When the steering wheel (not shown) is turned by a driver, input shaft 1 is thus turned about its axis together with torsion bar 3. Upon this, torsion bar 3 drives or turns pinion shaft 2 while being distorted because of the play between input and pinion shafts 1 and 2 provided by loose serration structure 15a. The degree of distortion of torsion bar 3 is detected by torsion sensor 9 by measuring a change of impedance of coils 9c, and a corresponding information signal is outputted to a control unit from coils 9c. By processing the distortion of torsion bar 3, a torque that should be actually applied to pinion shaft 2 from input shaft 1 is calculated by the control unit.

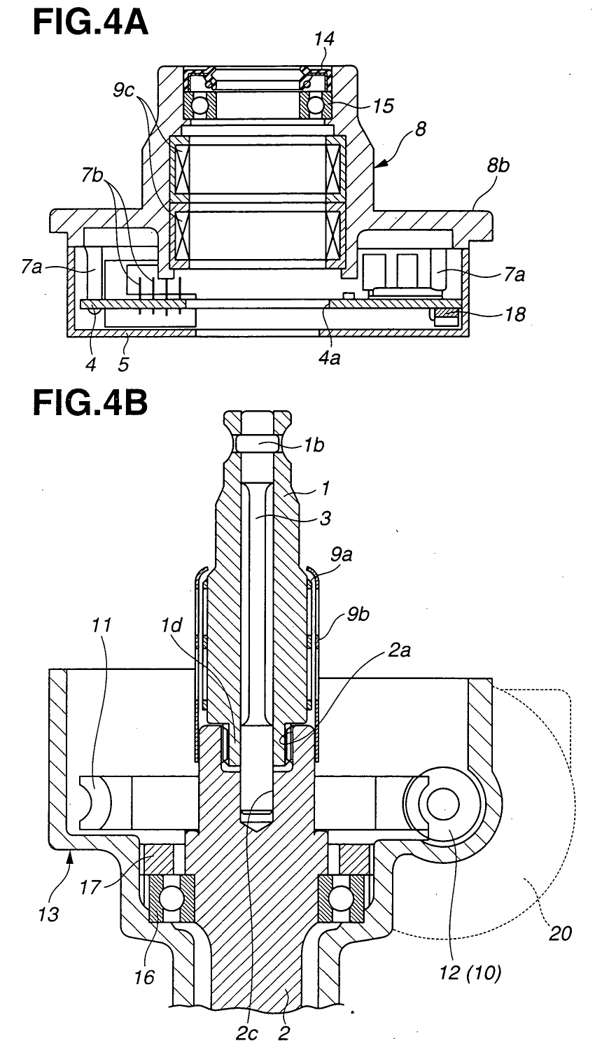

As is seen from FIGS. 3 and 4A, torque sensor housing 8 is formed at a lower part thereof with an integral larger base portion 8b that serves as a substrate supporting wall as will be apparent as the description proceeds.

As is seen from FIG. 1, larger base portion 8b of torque sensor housing 8 is integrally formed with a connector housing 19 in which an electric connector 19a is installed. An electric plug (not shown) is connected to electric connector 19a for feeding information signals to an electric circuit provided at an inner surface of larger base portion 8b of torque sensor housing 8.

Actually, as is seen from FIGS. 3 and 4A, the electric circuit is provided on a control system substrate 4 that is connected to the inner surface of larger base portion 8b.

That is, on the inner surface of larger base portion 8b, there is mounted the control system substrate 4 through stand members 7a. The above-mentioned electric connector 19a in connector housing 19 is connected to input terminals 7b of the electric circuit on control system substrate 4 by means of a flat cable (not shown) including a plurality of wires (viz., wire harness).

To a lower end surface of control system substrate 4, there is fixed a rotation angle sensor 18 that detects a rotation angle of brushless motor 20. Preferably, rotation angle sensor 18 is a MR (magnetic resistance effect) element. Rotation angle sensor 18 is positioned above a worm gear 10 that is integral with an output shaft 12 of brushless motor 20. Usage of the MR element brings about a compact construction of the rotation angle sensor 18.

The above-mentioned electric circuit on control system substrate 4 has a microcomputer that includes a central processing unit (CPU), a random access memory (RAM), a read only memory (ROM) and input and output interfaces. The electric circuit includes various sections which are a power steering control section, a torque sensor signal processing section, a motor speed sensing section, a rotation angle sensor signal processing section and a motor drive control section. Preferably, control system substrate 4 is covered with a plastic film for protecting the electric circuit thereon from a grease or the like that would be thrown from neighboring rotating parts.

As is seen from FIGS. 2 and 3, control system substrate 4 is formed at a generally center position thereof with a circular opening 4a in which the upper end of pinion shaft 2 is received leaving an annular clearance therebetween. As is seen from FIG. 3, upon assembly, control system substrate 4 supported by the larger base portion 8b of torque sensor housing 8 is neatly received in worm wheel housing 13.

As is seen from FIG. 3, pinion shaft 2 has an upper portion that is rotatably supported in worm wheel housing 13 through a ball bearing 16 that is tightly received in a stepped part (no numeral) of worm wheel housing 13 by means of a lock nut 17.

A worm wheel 11 is tightly disposed on the upper portion of pinion shaft 2 to rotate therewith.

Between worm wheel 11 and the above-mentioned control system substrate 4, there is positioned a partition or stopper wall 5 that protects the electric circuit of control system substrate 4 from a foreign matter, such as a grease or lubrication oil, that would be thrown from worm wheel 11.

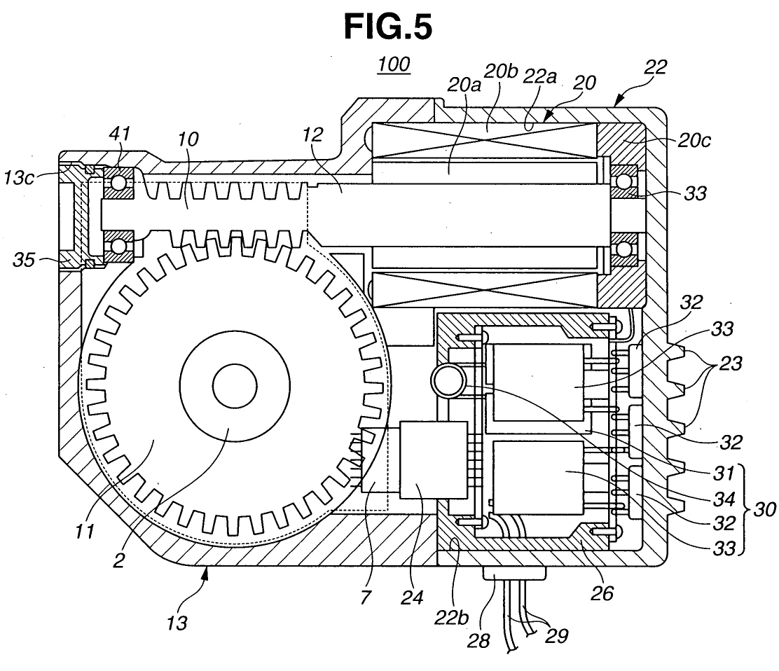

As is best seen from FIG. 5, worm wheel 11 is operatively engaged with worm gear 10 that is integrally formed on output shaft 12 of brushless motor 20 that is installed in motor housing 22.

Referring back to FIGS. 1 and 2, motor housing 22 is connected to a side wall of worm wheel housing 13. The side wall of motor housing 22 and that of worm wheel housing 13 are almost opened, and thus, when these two housings 22 and 13 are connected at the respective side walls, interiors of these housings 22 and 13 are merged to constitute a sufficiently large space for housing therein various parts and elements.

Referring back to FIG. 5, motor housing 22 has on an upper inner surface a motor holding recess 22a for holding a major portion of brushless motor 20 and on a lower inner surface a circuit holding recess 22b for holding a power system bracket 26.

As is seen from this drawing, brushless motor 20 generally comprises a cylindrical rotor 20a that is integrally and concentrically formed on output shaft 12 and a stator coil 20b that is tightly disposed in motor holding recess 22a while surrounding cylindrical rotor 20a. Of course, an annular but thinner clearance should be provided between cylindrical rotor 20a and stator coil 20b to carry out a smooth rotation of the rotor 20a without touching stator coil 20b.

Stator coil 20b is secured to holding recess 22a through a stator base 20c that is disposed about a ball bearing 33 by which a right end of output shaft 12 is rotatably supported. A left end of output shaft 12, that is, a left end of worm gear 10, is rotatably supported by another ball bearing 41 that is secured to an inner surface of a bore 13a formed in worm wheel housing 13. A sealing cap 35 is fitted to bore 13c to seal the same.

That is, output shaft 12 of brushless motor 20 is rotatably supported at right and left ends thereof by two bearings, which are the right ball bearing 33 and the left ball bearing 41. It is to be noted that there is no bearing member that rotatably supports a middle portion of output shaft 12.

As is seen from FIG. 5, stator coil 20b of the motor 20 and worm wheel 11 are positioned very close to each other for the purpose of shortening the length of output shaft 12. However, of course, there should be provided a certain but small clearance between the mutually closest parts of stator coil 20b and worm wheel 11 for avoiding interfering contact of stator coil 20b to cylindrical rotor 20a under rotation of output shaft 12. That is, stator coil 20b and worm wheel 11 are partially overlapped with each other with respect to an axis of output shaft 12.

In circuit holding recess 22b of motor housing 22, there is tightly disposed the above-mentioned power system bracket 26. On the bracket 26, there is arranged a power system substrate 30 on which condensers 31, power transistors 32, relays 33, coils 34, etc., are arranged.

As shown in FIG. 5, power system substrate 30 is compactly arranged with its upper part located near stator coil 20b of brushless motor 20 and its left part located near the right part of worm wheel 11.

As is seen from FIG. 2, upon assembly, the power system substrate 30 is placed at a position that is radially outside of the output shaft 12 of the motor 20 and radially outside of the worm wheel 11.

Referring back to FIG. 5, on an outer surface of motor housing 22 near power transistors 32, there are integrally formed heat radiation fins 23 for effectively radiating, to the open air, a heat that is produced by power transistors 32 under operation. Thus, the area of motor housing 22 where the heat radiation fins 23 are provided serves as a heat sink of power transistors 32. Considering the heat radiation ability needed by such area, motor housing 22 is preferably made of aluminum or its alloy.

Circuit holding recess 22b of motor housing 22 is formed with an opening (no numeral) through which electric power cables 29 are led into motor housing 22 and connected to a power input section of the power system substrate 30. For sealing the opening, a grommet 28 is fitted to the opening.

As is understood from FIGS. 2 and 5, a power system connector 24 held by power system bracket 26 mounted in motor housing 22 and a control system side connector 7 fixed to control system substrate 4 mounted on the inner surface of larger base portion 8b of torque sensor housing 8 are detachably connected to each other at a position where motor housing 22 and worm wheel housing 13 are mated at their mutually facing side walls.

As is understood from FIG. 2, upon assembly of electric power steering device 100, the connector 7 of torque sensor housing 8 and the connector 24 of motor housing 24 are connected to each other to provide an electric connection therebetween.

In the following, one example of steps for assembling electric power steering device 100 of the first embodiment will be described with reference to the drawings, especially FIG. 2.

Before the assembling, input shaft 1, pinion shaft 2, torsion bar 3 and worm wheel 11 are combined to constitute a semi-assembled shaft unit (1, 2, 3 and 11) in the above-mentioned manner, that is, in such a manner as is depicted by FIG. 3.

At first, as is seen from FIG. 2, three major units are prepared, which are a first unit 8U that includes torque sensor housing 8 in which torque sensor 9 and control system substrate 4 are mounted in the above-mentioned manner, a second unit 13U that includes worm wheel housing 13 in which ball bearings 16 and 41 are mounted in the above-mentioned manner, and a third unit 22U that includes motor housing 22 in which the power system substrate 30 and brushless motor 20 are mounted in the above-mentioned manner.

Then, as is understood from the drawing, the semi-assembled shaft unit (1, 2, 3 and 11) is put in worm wheel housing 13 of second unit 13U having worm wheel 11 received on a stepped bottom wall (see FIG. 3) of the housing 13.

Then, motor housing 22 of third unit 22U is connected at its open side wall to the open side wall of worm wheel housing 13 of second unit 13U by means of bolts 50 (see FIG. 1). Upon this connection, worm gear 10 on output shaft 12 of brushless motor 20 becomes engaged with worm wheel 11 of the semi-assembled shaft unit (1, 2, 3 and 11). For facilitating the engagement between worm gear 10 and worm wheel 11, insertion of output shaft 12 into worm wheel housing 13 may be carried out with its axis somewhat inclined relative to the common axis of the shaft unit (1, 2, 3 and 11).

Then, sealing cap 35 is fitted to bore 13c of worm wheel housing 13 to seal the same. As is mentioned hereinabove and seen from FIG. 5, upon this step, the leading end of output shaft 12, that is, the end of worm gear 10 is rotatably supported by ball bearing 41. That is, upon this, both ends of output shaft 12 are rotatably supported by the two ball bearings 33 and 41.

Then, as is understood from FIG. 2, torque sensor housing 8 of first unit 3U is disposed on worm wheel housing 13 of second unit 13U having the semi-assembled shaft unit (1, 2, 3 and 11) passed therethrough. During this, the semi-assembled shaft unit (1, 2, 3 and 11) is passed through circular center opening 4a of control system substrate 4 previously set in torque sensor housing 8.

Then, the control circuit side connector 7 on torque sensor housing 8 and the power system connector 24 mounted in motor housing 22 are mated to establish an electric connection therebetween.

Then, torque sensor housing 8 is secured to worm wheel housing 13 by means of bolts 52 (see FIG. 1).

It is to be noted that the mating between the two connectors 7 and 24 establishes an electric connection between the electric parts mounted in both torque sensor housing 8 and worm wheel housing 13 and the electric parts mounted in motor housing 22.

In the following, advantageous features of electric power steering device 100 of the first embodiment will be described.

Output shaft 12 of brushless motor 20 is rotatably supported at the axial ends thereof by only the two ball bearings 33 and 41. That is, in this first embodiment, there is no bearing member that supports a middle portion of output shaft 12 and thus the entire size of the electric power steering device 100 can be reduced by a degree corresponding to the size of the bearing member that would bear the middle portion of output shaft 12. Actually, the middle portion of output shaft 12 is substantially supported by the teeth of worm wheel 11. Since such third bearing member is not provided, a sufficiently large engaging zone is provided by worm gear 10 and worm wheel 11, which induces an assured engagement between worm gear 10 and worm wheel 11.

As is seen from FIG. 2, control system substrate 4 is connected to integral larger base portion 8b of torque sensor housing 8 in which torque sensor 9 is installed. This means that control system substrate 4 and torque sensor 9 can be positioned very close to each other, and thus, a wire harness or cable used for connecting these two parts 4 and 9 can have a shorter length, which brings about a compact and cost reduced construction of electric power steering device 100.

Usage of brushless motor 20 facilitates the assembling work of mounting the same to the proper position of motor housing 22. That is, if the motor 20 is of a brush type that has a brush and a commutator, the mounting of motor to the proper position needs a troublesome and time-consumed assembling work because such work tends to cause deformation of the brush and the commutator.

As is described hereinabove and seen from FIG. 4, when motor housing 22 and worm wheel housing 13 are properly coupled, interiors of these housings 22 and 13 become merged because of their open side walls which are connected. This brings about an ease with which the various electric parts are arranged in the device 100.

Due to the nature of its construction, operation of brushless motor 20 is not severely affected by a grease that would be thrown thereto from worm wheel 11 or worm gear 10 under operation. That is, there is no need of providing worm wheel housing 13 with a so-called grease stopper, and thus compactness of electric power steering device 100 is promoted.

Because worm wheel housing 13 and motor housing 22 are constructed as separate members, second unit 13U and third unit 22U can be pre-assembled separately before their coupling. Thus, assembling process of the device 100 can be facilitated.

As is seen from FIG. 5, when worm wheel housing 13 is properly connected to motor housing 22, the left end of output shaft 12 (or worm gear 10) of motor 22 mounted in motor housing 22 is inserted into a center bore of ball bearing 41. This facilitates the assembling process of the device 100. Sealing cap 35 fitted in bore 13c prevents a leakage of a grease from the interior of worm wheel housing 13 to the outside.

As is described hereinabove and seen from FIG. 5, stator coil 20b of the motor 20 and worm wheel 11 are positioned very close to each other. Thus, the length of output shaft 12 of the motor 20 can be reduced, which promotes the compactness of the device 100.

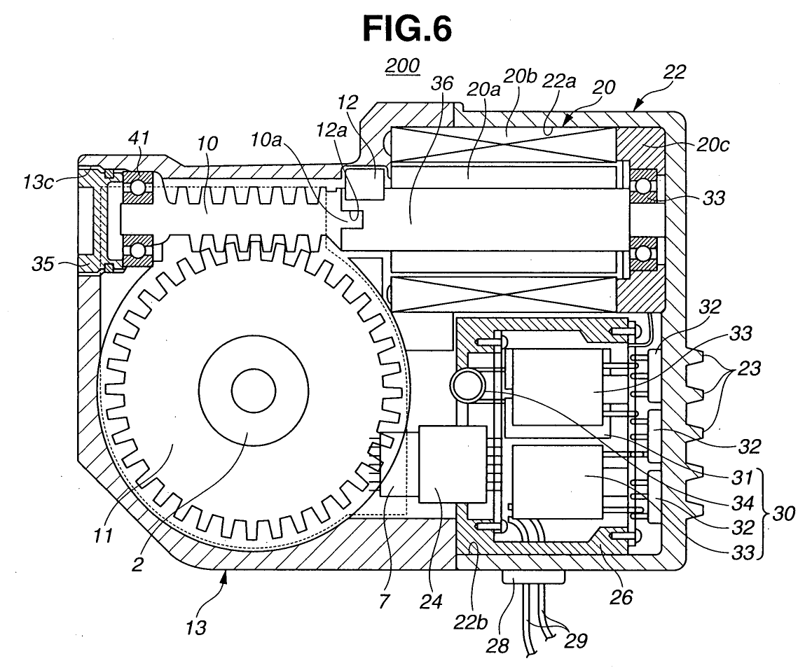

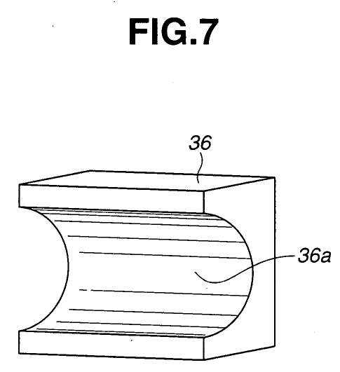

Referring to FIGS. 6 and 7, there is shown an electric power steering device 200 which is a second embodiment of the present invention.

Since electric power steering device 200 of this second embodiment is similar in construction to the device 100 of the above-mentioned first embodiment, only parts or portions that are different from those of the first embodiment 100 will be described in detail in the following.

That is, as is seen from FIG. 6, in the second embodiment 200, worm gear 10 and output shaft 12 are separate members. As shown, for tightly connecting these two members 10 and 12, a press-fitting technique is used. That is, a rectangular projection 10a formed in one end of worm gear 10 is press-fitted into a rectangular recess 12a formed in one end of output shaft 12. With this, a combined shaft structure (10+12) is produced.

As is seen from FIG. 6, a shaft holding member 36 is fixed to the inner surface of wheel housing 13 to bear a generally middle portion of the combined shaft structure (10+12).

As is seen from FIG. 7, shaft holding member 36 is formed with a concave recess 36a by which the middle portion of the combined shaft structure (10+12) is rotatably held.

As is seen from FIGS. 6 and 7, shaft holding member 36 is arranged at diametrically opposite and axially spaced position of worm wheel 11 with respect to the combined shaft structure (10+12). With this arrangement, shaft holding member 36 can optimally receive any stress that would be applied to the shaft structure (10+12) from worm wheel 11 under operation.

To those skilled in the art, it is easily understood that due to the similar construction, the various advantages of the device 100 of the first embodiment are equally possessed by the device 200 of the second embodiment. It is to be noted that in the second embodiment 200, the shaft holding member 36 is not a member that entirely surrounds the shaft structure (10+12) like the ball bearing 33 or 41, but a member that holds a part of the shaft structure (10+12).

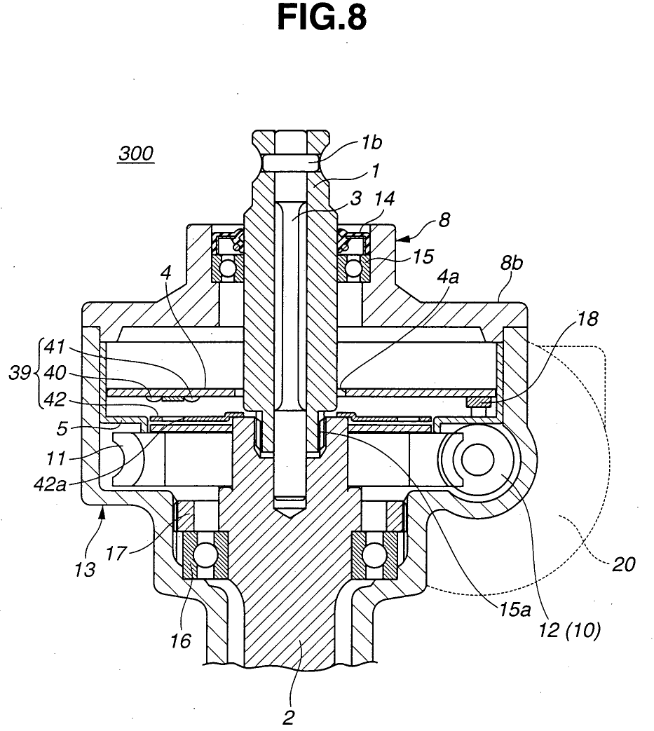

Referring to FIG. 8, there is shown an electric power steering device 300 which is a third embodiment of the present invention.

Since electric power steering device 300 of this third embodiment is similar in construction to the device 100 of the above-mentioned first embodiment, only parts or portions that are different from those of the first embodiment 100 will be described in detail in the following.

That is, in this third embodiment 300, an optical torque sensor 39 is used in place of the above-mentioned magnetic type torque sensor 9.

As shown in the drawing, optical torque sensor 39 comprises an infrared emission element 40 and an infrared receiving element 41 that are mounted on a lower surface of control system substrate 4, and a disc member 42 that is fixed to pinion shaft 2 to rotate therewith. As shown, disc member 42 is arranged between control system substrate 4 and worm wheel 11 and formed with a plurality of slits 42a that are circumferentially arranged at equally spaced intervals.

Upon turning of input shaft 1 due to turning of the steering wheel (not shown), there is a delay of turning of pinion shaft 2 due to the work of loose serration structure 15a, which causes distortion of torsion bar 3. The degree of the distortion is detected by comparing frequency of ON condition wherein an infrared ray emitted from infrared emission element 40 is received by infrared receiving element 41 after being reflected back by a solid part of disc member 42 and frequency of OFF condition wherein the infrared ray emitted from infrared emission element 40 fails to reach infrared receiving element 41 because the ray passes through the slit 42a of disc member 42. By processing the detected distortion of torsion bar 3, a torque that should be actually applied to pinion shaft 2 from input shaft 1 is calculated by the control unit.

Because both infrared emission element 40 and infrared receiving element 41, which are the major parts of optical torque sensor 39, are mounted on control system substrate 4, electric connection between each element 40 or 41 and the circuits on the substrate 4 is easily and compactly achieved as compared with the above-mentioned first and second embodiments 100 and 200.

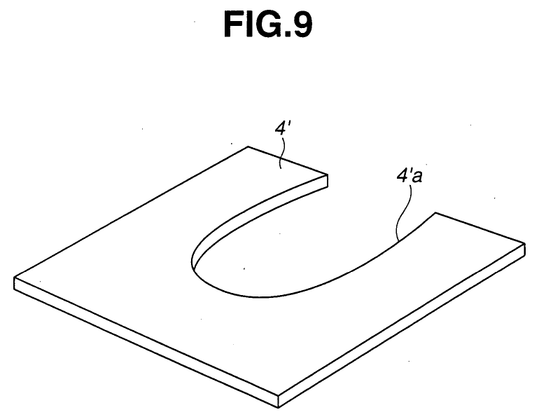

Referring to FIG. 9, there is shown a modified control system substrate 4′ that is usable in place of the above-mentioned control system substrate 4. That is, in this modification 4′, a generally U-shaped recess or cut 4′a is formed in the substrate.

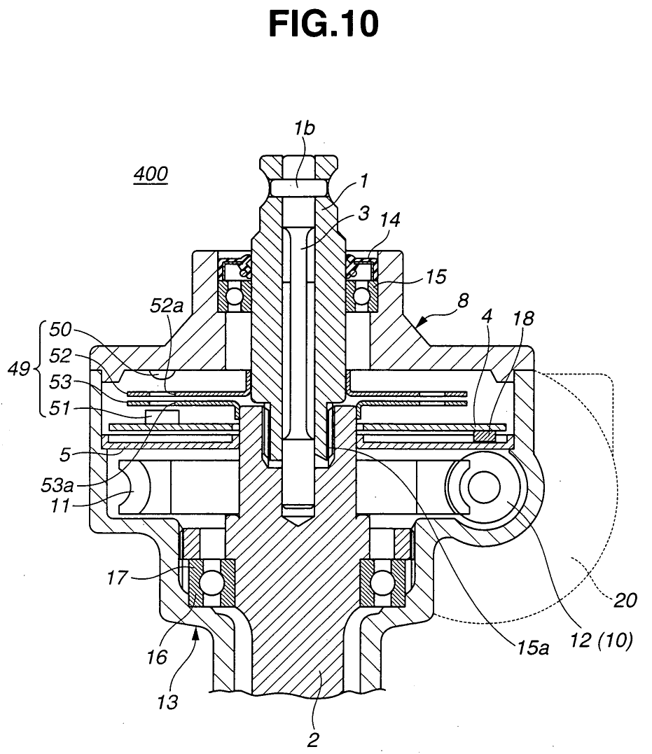

Referring to FIG. 10, there is shown an electric power steering device 400 which is a fourth embodiment of the present invention.

Like the above-mentioned devices 200 and 300 of the second and third embodiments, electric power steering device 400 of this fourth embodiment is similar to the device 100 of the first embodiment, only parts or portions that are different from those of the first embodiment 100 will be described in detail in the following.

In this fourth embodiment 400, an optical torque sensor 49 is used. As shown, optical torque sensor 49 comprises an infrared emission element 50 that is secured to an inner upper surface of torque sensor housing 8, an infrared receiving element 51 that is secured to an upper surface of control system substrate 4, a first disc member 52 that is secured to input shaft 1 to rotate therewith and a second disc member 53 that is secured to pinion shaft 2 to rotate therewith. Each of first and second disc members 52 and 53 is formed with a plurality of slits 52a or 53a which are circumferentially arranged at equally spaced intervals. As shown, first and second disc members 52 and 53 are arranged between infrared emission element 50 and infrared receiving element 51.

Upon turning of input shaft 1 due to turning of the steering wheel (not shown), there is a delay of turning of pinion shaft 2 due to the work of loose serration structure 15a, which causes distortion of torsion bar 3. The degree of the distortion is detected by comparing frequency of ON condition wherein an infrared ray emitted from infrared emission element 50 is received by infrared receiving element 51 after passing through the aligned slits of first and second disc members 52 and 53 and frequency of OFF condition wherein the infrared ray emitted from infrared emission element 50 fails to reach infrared receiving element 51 due to misalignment of the slits of first and second disc members 52 and 53. As has been mentioned hereinabove, by processing the detected distortion of torsion bar 3, a torque that should be actually applied to pinion shaft 2 from input shaft 1 is calculated by the control unit.

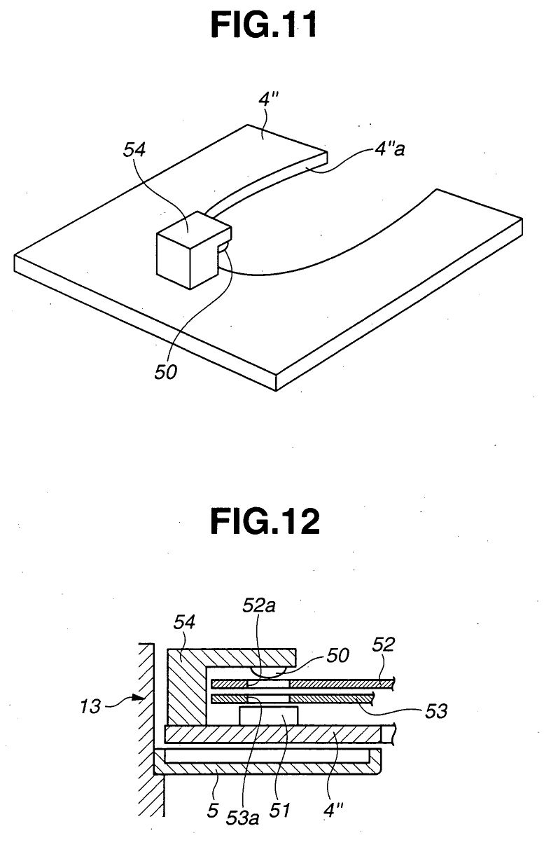

Referring to FIGS. 11 and 12, there is shown a modified control system substrate 4″ that is usable in the device 400 of the fourth embodiment. That is, in this modification 4″, a generally U-shaped recess or cut 4″a is formed in the substrate 4″.

Furthermore, as is well seen from FIG. 12, an element holder 54 is fixed to the substrate 4″ for holding infrared emission element 50. Thus, in this case, both infrared emission element 50 and infrared receiving element 51 are held by control system substrate 4″.

The entire contents of Japanese Patent Applications 2004-039723 filed Feb. 17, 2004 and 2004-083223 filed Mar. 22, 2004 are incorporated herein by reference.

Although the invention has been described above with reference to the embodiments of the invention, the invention is not limited to such embodiments as described above. Various modifications and variations of such embodiments may be carried out by those skilled in the art, in light of the above description.

1. An electric power steering device comprising:
a worm wheel mounted to a steered shaft to rotate therewith;
a brushless electric motor having an output shaft, the motor being able to generate a power for assisting turning of the steered shaft when energized;
a worm gear coaxially connected to the output shaft of the motor to constitute a combined shaft structure, the worm gear being meshed with the worm wheel; and
two bearings that bear axially opposite end portions of the combined shaft structure respectively.

2. An electric power steering device as claimed in claim 1, further comprising:
a motor housing that houses the motor, the motor housing having an open side wall; and
a gear housing that houses the worm gear, the gear housing having an open side wall,
the open side wall of the motor housing and the open side wall of the gear housing being mated thereby to merge an interior of the motor housing with that of the gear housing.

3. An electric power steering device as claimed in claim 2, in which the motor housing and the gear housing are separate members.

4. An electric power steering device as claimed in claim 1, in which the worm gear and the output shaft are separate members and coaxially connected to each other.

5. An electric power steering device as claimed in claim 1, in which the worm gear and the output shaft are of a single-piece construction.

6. An electric power steering device as claimed in claim 1, in which a stator of the motor and the worm wheel are partially overlapped with respect to an axis of the combined shaft structure.

7. An electric power steering device comprising:
a steered shaft connected to a steering wheel;
a steering condition detecting device that detects a steering condition of the steered shaft;
a worm wheel secured to the steered shaft to rotate therewith;
a brushless electric motor having an output shaft, the motor being able to generate a power for assisting turning of the steered shaft when energized;
a worm gear coaxially connected to the output shaft of the motor to constitute a combined shaft structure, the worm gear being meshed with the worm wheel;
two bearings that bear axially opposite end portions of the combined shaft structure;
a power system substrate on which power transistors for feeding the motor with a controlled electric power are mounted; and
a control system substrate positioned in the vicinity of both the steering condition detecting device and the worm wheel, the control system substrate carrying thereon a microcomputer by which the power transistors are controlled based on the steering condition detected by the steering condition detecting device, the control system substrate having an opened portion through which the steered shaft passes.

8. An electric steering device as claimed in claim 7, in which the control system substrate is positioned between the steering condition detecting device and the worm wheel, and in which the opened portion of the control system substrate is a circular opening formed in a generally center portion of the control system substrate.

9. An electric steering device as claimed in claim 7, in which the power system substrate is placed at a position that is radially outside of the output shaft of the motor and radially outside of the worm wheel.

10. An electric steering device as claimed in claim 7, in which the power system substrate having a power system connector for receiving information signal from a circuit on the control system substrate, the power system connector being positioned at the same level as the control system substrate when assembled.

11. An electric steering device as claimed in claim 7, in which a partition wall is provided between the control system substrate and the worm wheel to protect the control system substrate from a foreign matter that would be thrown from the worm wheel.

12. An electric steering device as claimed in claim 7, further comprising a motor housing for housing the brushless electric motor and the power system substrate, the motor housing being formed with heat radiation fins for effectively radiating, to the open air, a heat that is generated by the power system substrate.

13. An electric steering device as claimed in claim 7, in which electric elements on the control system substrate and the steering condition detecting device are partially overlapped in a direction of the axis of the steered shaft.

14. An electric steering device as claimed in claim 7, in which the steering condition detecting device is a torque sensor.

15. An electric steering device as claimed in claim 7, in which the steering condition detecting device is a steering angle sensor.

16. An electric power steering device arranged between a first section that includes a steering wheel and a second section that includes steered road wheels of a motor vehicle, the electric power steering device comprising:
an input shaft connected to the first section;
a pinion shaft connected to the second section and coaxially connected to the input shaft through a torsion bar;
a worm wheel mounted to the pinion shaft to rotate therewith;
a brushless electric motor arranged in such a manner that an output shaft thereof extends perpendicular to an axis of the pinion shaft;
a worm gear provided by the output shaft of the motor and operatively meshed with the worm wheel; and
two ball bearings only by which the output shaft is rotatably supported, the two ball bearings bearing axially opposite end portions of the output shaft respectively.
